(19) United States
(12) Patent Application Publication
(10) Pub. No.: US 2024/0127059 A1
(43) Pub. Date: Apr. 18, 2024

(54) AD HOC MACHINE LEARNING TRAINING THROUGH CONSTRAINTS, PREDICTIVE TRAFFIC LOADING, AND PRIVATE END-TO-END ENCRYPTION

(71) Applicant: Tektronix, Inc., Beaverton, OR (US)

(72) Inventor: Keith R. Tinsley, Eugene, OR (US)

(73) Assignee: Tektronix, Inc., Beaverton, OR (US)

(21) Appl. No.: 18/482,801

(22) Filed: Oct. 6, 2023

Related U.S. Application Data
(60) Provisional application No. 63/415,505, filed on Oct. 12, 2022.
(60) Provisional application No. 63/429,508, filed on Dec. 1, 2022.

(51) Int. Cl. G06N 3/08

(52) U.S. Cl. CPC G06N 3/08

(57) ABSTRACT

A machine learning network has a plurality of test and measurement devices, one or more of the test and measurement devices has one or more communication interfaces configured to allow the device to receive and process physical layer signals, a memory, and one or more processors configured to execute code to cause the one or more processors to receive physical layer data, perform one or more operations on the physical layer data according to a machine learning model to produce changed physical layer data, and transmit the changed physical layer data to at least one other node in the machine learning neural network. The machine learning network may include a learner node.

### CROSS-REFERENCE TO RELATED APPLICATIONS

This disclosure claims benefit of U.S. Provisional Application No. 63/415,505, titled “AD HOC MACHINE LEARNING TRAINING THROUGH CONSTRAINTS, PREDICTIVE TRAFFIC LOADING, AND PRIVATE END-TO-END ENCRYPTION,” filed on Oct. 12, 2022, and U.S. Provisional Application No. 63/429,508, titled “AI.ML CELL COMPONENT OF A TEST, MEASUREMENT, AND SUSTAINMENT NETWORK FOR COMMUNICATIONS LINKS,” filed on Dec. 1, 2022, the disclosures of which are incorporated herein by reference in their entirety.

### TECHNICAL FIELD

This disclosure relates to test and measurement systems, and more particularly to systems for testing, measuring, and sustainment (TMS) of physical layer signals, including but not limited to optical and electromagnetic signals, in a network.

### BACKGROUND

The increasing prevalence of faster communications standards, Wi-Fi, 6G (6^{th} generation), and the Internet of Things (IoT), provides opportunities for emerging technologies to become not only possible but practical. Distributed computing has become a very prevalent technology, as has machine learning. However, the increased communications speeds and stability of the communications links has raised interest in distributed machine learning.

Federated learning represents one such architecture. Federated learning involves a distribution of the learning process out to the edge devices in a network, where the edge devices train the models using their own local data. Typically, a generic model resides on a central server or data center and with copies of the model being shared to the edge devices. The edge devices train the model on the data local to them. However, methods to implement these types of system are lacking.

A particular area in which this type of system is lacking is in the domain of testing, measurement, and sustainment of physical layer signals, such as those employed by the communication network itself to test, measure and validate the network infrastructure. This contrasts with the use of federated learning that relies on the network infrastructure to do other tasks.

### BRIEF DESCRIPTION OF THE DRAWINGS

FIG. 1 shows a network diagram of a communications network having multiple nodes.

FIG. 2 shows a diagram of a cell tuple in a communications network.

FIG. 3 shows a flow chart of an embodiment of a method of adding new nodes to a communications network employing machine learning.

### DESCRIPTION

Embodiments herein employ a network of nodes for test and measurement, including test and measurement of the network infrastructure itself. Nodes in the network operate as nodes of a machine learning neural network and operate on physical layer (PHY) signals through application of artificial intelligence (AI)/machine learning (ML) input vectors. The term “physical layer data” as used here encompasses both physical layer signals and data that may be contained in those signals.

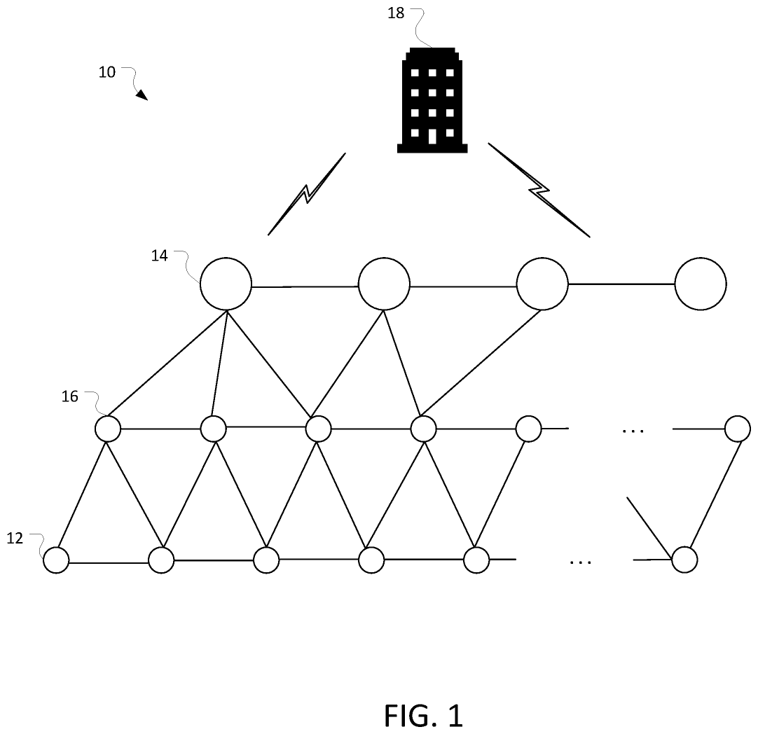

FIG. 1 shows an example of a communications network 10 having a plurality of test and measurement devices as nodes, such as 12. Each node comprises a processing unit trainable to a machine learning—artificial intelligence model. This discussion uses the terms “artificial intelligence” and “machine learning” to refer to algorithms and processes that can receive information and act upon it without human intervention. These algorithms and processes may undergo training to cause the model to converge, meaning that no further training or inputs will increase the model's error rate/prediction percentage.

Once trained, the nodes will operate to test and monitor the network infrastructure, the communications links and nodes. In many machine learning systems, the machine learning model may operate on information received from various input sources to perform particular tasks, such as image processing and recognition in a facial recognition system, or gathering of sustainment data in telecommunications system, as examples.

The nodes represent hundreds of thousands, if not millions, of distributed sensors. These sensors may include test and measurement instruments, antennas, broadcast hubs, signal sensors, such as spectral sensors, reconfigurable intelligent surfaces (RIS), etc. Different nodes may have different capabilities resulting in different trained models, such as non-independent and non-identically distributed models (non-iid). Some nodes may comprise simple sensors with a processing element with limited capacity, and memory. More capable sensors may comprise computing devices, such as general-purpose computing devices, servers, and test and measurement instruments such as spectrum analyzers, oscilloscopes, multimeters, etc.

Moreover, in totality, each individual trained model forms fundamental component signatures, nodes (nuclei) that form cells having targeted, predetermined, purpose, which comprise a corpus for efficient monitoring targeted system. In one embodiment the targeted system comprises a 6G telecommunication system. In the case of measurement of vital signs, which are necessary for the fundamental operations, the embodiments focus on methods and apparatus to systematically test, measure, and sustain these system(s).

Returning to FIG. 1, each node such as 12 connects with other nodes such as 14 and 16. The links between the nodes shown here only comprise a representation of the connectivity of the nodes in the network. In some embodiments, a data center or central hub 18 provides overall network control, and may, as will be discussed in more detail below, provide a general machine learning model, or algorithm, to the nodes in the network.

Each node, or device, in the network contains an AI/ML convergence engine capable of taking receipt of prescribed information, and acting on said information, ideally through execution of the ML model. The node can determine change parameters to the prescribed data for passage back to the node that delivered the task based upon the status of the communications links on which that node resides. The node can also establish a bidirectional link that allows for transmission of learning data (vectors) through the network, and passage up (back into the network) of PHY layer data for correlation of cause with effect, marking system state over time.

In some embodiments, the nodes may take or receive data processed by a more capable node (sensor). In some embodiments, the system uses predictive assessment of traffic loading, along with knowledge of sensor capabilities, routing delays, and security needs, to determine optimal distribution of learning vectors (training data) across the network, such as the TekCloud® network, allowing for correlation of measured physical parameters and delivered AI/ML learning (training) data.

The various nodes may employ a UDP (User Datagram Protocol) routing approach, avoiding IP routing, because it offers the best speed (i.e., multicast), and employs zero proof knowledge of the link prior to transmission. In some instances, the links can also employ blockchain validation as an added layer of security for both data integrity protection and data owner-controlled distribution through fungible token, proprietary key, or some combination of both.

The network can use the organized delivery of AI/ML learning (training) data to target nodes, and their corresponding physical measurements, to form a “living” history of the system, allowing for version control of changes, among other advantages. Systems using the disclosed technology will be detectable by the system owner's ability to reconstitute a system, to a prior state, without need for communicated outage to end users.

Some embodiments involve the addition of a node to the network. As mentioned above, the node could comprise one of many different types of devices. The “addition” of a node includes the re-training of a node in which the model has “collapsed,” where the model no longer operates within a given range of error/accuracy of predictions.

The node, referred to here as a “learning node,” operates under similar principles to federated learning within machine learning. In federated learning, edge devices, those devices at the edge of a network, receive a basic model that may or may not have received some level of training. The edge device then trains the model operating on the device with data sets derived from data local to the device. This may result in different devices having slightly different trained models, such as the weights assigned to different results. In large networks, this has the advantage that the devices across the network operate in different environments, including differences in transmission media available, different devices constituting nearby nodes, etc.

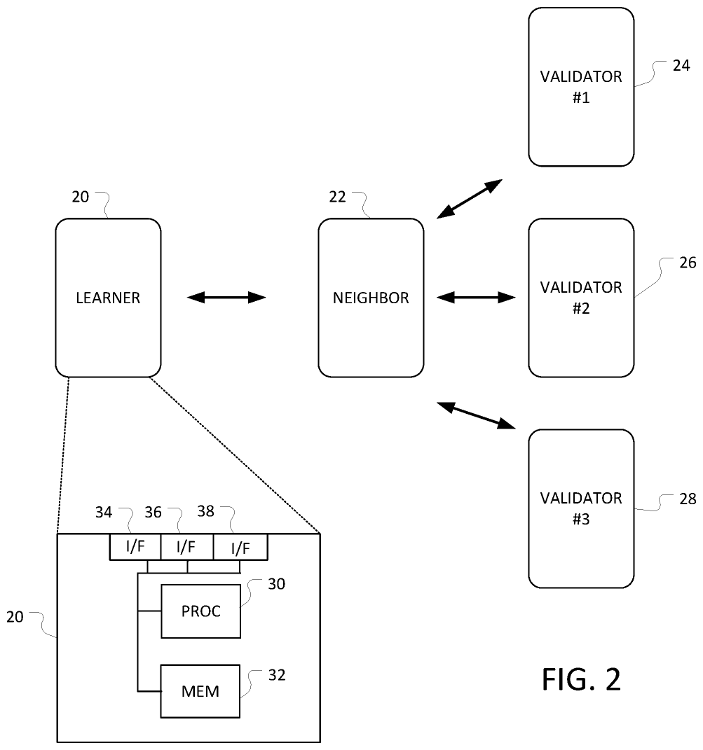

The embodiments involve foundations of the messaging between nodes of such a network to perform actions related to machine learning. The embodiments define a pod, or a tuple, of nodes willing to participate in determining resolution of an ML model desired by the learner node. FIG. 2 shows an embodiment of a tuple. The tuple will comprise the learner node, a neighbor node, and at least one validator node. The neighbor node may comprise one of many nodes selected by the learner, as discussed in more detail below.

Embodiments generally use an ML-enabled cell. FIG. 2 shows an embodiment of a learner node 20, with the understanding that any of the other nodes in the tuple, or across the network, may have the same structure. In FIG. 2, the learner node has a processing element of some kind. This could include a general-purpose processor, a graphics processing unit, a digital signal processor, a microcontroller, a Field Programmable Gate Array (FPGA), as examples. This discussion refers to any device capable of executing code, including code as part of a machine learning model, as a “processor” 30. The nodes also have at least one, but typically several, communication links interfaces, such as 34, 36, and 38. These may include wired, wireless, including wi-fi, other radio protocols, and near-field communications, and optical interfaces. Each node will have at least some form of memory 32. As discussed in more detail below, the memories of each node may maintain model versions and histories.

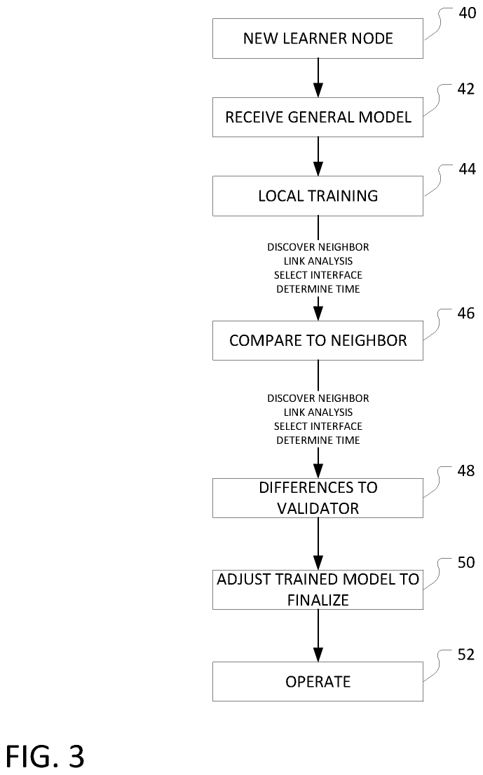

The following discussion uses the tuple shown in FIG. 2 with the flowchart of FIG. 3. Initially, the learner node 20 is added to the network of nodes at 40 in FIG. 3. As mentioned above, the learner node may represent an existing node that needs to undergo retraining, essentially starting itself over. The learner node receives the general model at 42. For existing nodes undergoing retraining, this may involve accessing its memory to retrieve the initial model upon which it trained. Using local data as the training data, the node undergoes training to produce a trained model at 44. The node then needs to discover its neighbors.

All nodes may discover each other in one of two ways. A new node may receive information through a beacon or other communication through one of the communication interfaces, which it may then save into its memory. For example, as the learner node completes the training of the general model with its local data, the learner node will discover the neighbor node or nodes by accessing the previous-received information and sending requests to one of those nodes, or possibly to many of the nodes, and then wait to receive replies. In a second manner, the learner node could send a broadcast message out to all neighbor nodes and then receive replies. The learner node may select the neighbor, either based upon replies or the previously received information, based upon the information received about that node and the link between the two nodes.

The information may include an analysis of the links available between the two nodes. Some communication links may have good speed, but low accuracy, or low speed and high accuracy. Some communication links may not be available, for example, one device may not have an optical communication channel. The node may also analyze the amount of time the other node estimates it will take for the other node to work with the learner node, possibly in light of an overall time given to the learner node. All the participants, learner nodes, neighbor nodes and validator nodes, may share each of their contribution to the overall time.

The node selects a node as the neighbor node shown as 22 in FIG. 2 based upon this information. The two nodes then perform a comparison between their models, such as the weights, error levels, etc. at 46. If no differences exist, or no differences outside a threshold tolerance for differences, the process may end, the network identifies the node as trained, and the node goes into operation at 52. If differences do exist that need reconciliation, the third node in the tuple, a validator node shown as one of nodes 24, 26, or 28 in FIG. 2, enters the process at 48. The discovery process of available validator nodes may take the form of the previous discovery process, or the information gathered during that process may allow identification and selection of the validator node.

The learner node or the neighbor node sends the results of the comparison, the difference(s) to the validator node. The validator node analyzes the differences and may adjust the weights, etc. of the trained model on the learner node and returns those changes to the learner node. The learner node then adjusts its trained model at 50 and goes into operation at 52. In a secondary process, the validator may communicate changes to the neighbor node as well. Once in operation, the new node may become available as a neighbor node or a validator for new nodes or those undergoing retraining.

In this manner, all participants in the process know the ML task time for each node, and their means of completing their task will be done by overall governing parameters afforded to each node. These may include power consumption, maximum wake time, etc., just to name a few. This will translate into policy parameters for products/equipment/nodes that join to conduct a needed ML task.

Embodiments of the disclosure include the methods, attributes, and interplay between components that form the minimum architecture needed to support the joint intelligence for ML in a distributed sensing, wired or wireless communication environment. Embodiments of the disclosure further include using this architecture, in conjunction with PHY layer measurements, to set a metrology standard that other, third party, ML engines can tune themselves against.

Some example non-limiting embodiments include the use of a calibrated RF channel sounding measurement or apriori determination of optimal beam alignments, resulting in reduced codebook dimensions, for a 6G use case and determining a time invariant channel (TIV) between 6G users, engaged in a point-to-point communication link. Embodiments use transference of data beforehand to allow for better and faster data transmissions. Embodiments generally do so through calibration of the link adjacent to the mainline communication protocols either during, or before, commencement of the 6G link. ML techniques will determine this channel, having results determined through use of the architecture discussed here.

Aspects of the disclosure may operate on particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### Examples

Illustrative examples of the disclosed technologies are provided below. An embodiment of the technologies may include one or more, and any combination of, the examples described below.

Example 1 is a machine learning network, comprising: a plurality of test and measurement devices; one or more of the test and measurement devices comprising: one or more communication interfaces configured to allow the device to receive and process physical layer signals; a memory; and one or more processors configured to execute code to cause the one or more processors to receive physical layer data; perform one or more operations on the physical layer data according to a machine learning model to produce changed physical layer data; and transmit the changed physical layer data to at least one other node in the machine learning neural network.

Example 2 is the machine learning network as claimed in claim 1, wherein the test and measurement devices comprise one or more of test and measurement instruments, sensors, antennas, reconfigurable intelligent surfaces, general purpose computing devices, and servers.

Example 3 is the machine learning network of either of Examples 1 or 2, wherein the physical layer signals comprise transmission rate, encoding, transmission media, and interface.

Example 4 is the machine learning network of any of Examples 1 through 3, wherein the code that causes the one or more processors to perform operations comprises code that causes the one or more processors to perform at least one of determining change parameters for returning data to a node that sent the physical layer data, determining beam alignment, canceling interference, and channel estimation.

Example 5 is the machine learning network of any of Examples 1 through 4, wherein signals in the network use User Datagram Protocol (UDP) signaling for signals sent between nodes.

Example 6 is a learner node, comprising: one or more communication interfaces; a memory; and one or more processors, each processor configured to execute code to cause the processor to: receive a general machine learning model through one of the one or more communication interfaces; use data local to the learning node to train the model; discover one or more neighbor nodes; communicate with the one or more neighbor nodes to compare the trained model to a neighbor node; determine a difference between the trained model and the neighbor model; discover one or more validator nodes; send the difference to the one or more validator nodes; receive inputs from the one or more validator nodes; and adjust the trained model as necessary based upon the inputs to complete the trained model.

Example 7 is the learner node of Example 6, wherein the one or more processors are further configured to execute code to receive, through one of the one or more communication interfaces, information about one or more neighbor nodes, and information about each connection to each neighbor node, prior to executing the code that causes the one or more processors to discover the one or more neighbor nodes.

Example 8 is the learner node of Example 7, wherein the code executed by the one or more processors to cause the one or more processors to discover the one or more neighbor nodes comprises code to cause the one or more processors accessing the memory to retrieve data about the one or more neighbor nodes and a connection between the learner node and the one or more neighbor nodes.

Example 9 is the learner node of any of Examples 6 through 8, wherein the code executed by the one or more processors to cause the one or more processors to discover the one or more neighbor nodes comprises code to cause the one or more processors to send out a request and to receive at least one response from at least one of the one or more neighbor nodes, the response including information about at least one of a communication link between the learner node and the at least one of the one or more neighbor nodes, and job completion time for the at least one of the one or more neighbor nodes.

Example 10 is the learner node of any of Examples 6 through 9, wherein the code that causes the one or more processors to execute code to communicate with the one or more neighbor nodes causes the one or more processors to communicate with the neighbor node based upon the information about the communication link and the job completion time.

Example 11 is the learner node of Example 10, wherein the information about the communication link comprises at least one of amount of time to respond, a selected one of the one or more communication interfaces, a needed precision, power consumption of the neighbor node, and maximum wake time of the neighbor node.

Example 12 is the learner node of any of Examples 6 through 11, wherein the code executed by the one or more processors to send the difference to a validator node comprises code to cause the one or more processors to send the differences to one of the one or more validator nodes based upon information about a communication link between the learning node and the one validator node.

Example 13 is the learner node of any of Examples 6 through 12, wherein the code that causes the one or more processors to adjust the trained model comprises code that causes the one or more processors to adjust weights in the trained model based upon the inputs.

Example 14 is the learner node of any of Examples 6 through 13, wherein the one or more processors are further configured to execute code to receive a maximum time for completion of the trained model.

Example 15 is the learner node of any of Examples 6 through 14, wherein upon completion of the trained model, the learning node becomes at least one of a neighbor node or a validator node.

Example 16 is the learner node of any of Examples 6 through 15, wherein the one or more processors are further configured to execute code to store in the memory one or more of trained model histories and versions, completion times for the one or more neighbor nodes and the one or more validator nodes.

Example 17 is the learner node of any of Examples 6 through 16, wherein the one or more processors are further configured to participate in a communications network as a sensor node operating the trained model upon completion of the trained model.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

1. A machine learning network, comprising:
a plurality of test and measurement devices;
one or more of the test and measurement devices comprising:
one or more communication interfaces configured to allow the device to receive and process physical layer signals;
a memory; and
one or more processors configured to execute code to cause the one or more processors to receive physical layer data;
perform one or more operations on the physical layer data according to a machine learning model to produce changed physical layer data; and
transmit the changed physical layer data to at least one other node in the machine learning neural network.

2. The machine learning network as claimed in claim 1, wherein the test and measurement devices comprise one or more of test and measurement instruments, sensors, antennas, reconfigurable intelligent surfaces, general purpose computing devices, and servers.

3. The machine learning network as claimed in claim 1, wherein the physical layer signals comprise transmission rate, encoding, transmission media, and interface.

4. The machine learning network as claimed in claim 1, wherein the code that causes the one or more processors to perform operations comprises code that causes the one or more processors to perform at least one of determining change parameters for returning data to a node that sent the physical layer data, determining beam alignment, canceling interference, and channel estimation.

5. The machine learning network as claimed in claim 1, wherein signals in the network use User Datagram Protocol (UDP) signaling for signals sent between nodes.

6. A learner node, comprising:
one or more communication interfaces;
a memory; and
one or more processors, each processor configured to execute code to cause the processor to:
receive a general machine learning model through one of the one or more communication interfaces;
use data local to the learning node to train the model;
discover one or more neighbor nodes;
communicate with the one or more neighbor nodes to compare the trained model to a neighbor node;
determine a difference between the trained model and the neighbor model;
discover one or more validator nodes;
send the difference to the one or more validator nodes;
receive inputs from the one or more validator nodes; and
adjust the trained model as necessary based upon the inputs to complete the trained model.

7. The learner node as claimed in claim 6, wherein the one or more processors are further configured to execute code to receive, through one of the one or more communication interfaces, information about one or more neighbor nodes, and information about each connection to each neighbor node, prior to executing the code that causes the one or more processors to discover the one or more neighbor nodes.

8. The learner node as claimed in claim 7, wherein the code executed by the one or more processors to cause the one or more processors to discover the one or more neighbor nodes comprises code to cause the one or more processors accessing the memory to retrieve data about the one or more neighbor nodes and a connection between the learner node and the one or more neighbor nodes.

9. The learner node as claimed in claim 6, wherein the code executed by the one or more processors to cause the one or more processors to discover the one or more neighbor nodes comprises code to cause the one or more processors to send out a request and to receive at least one response from at least one of the one or more neighbor nodes, the response including information about at least one of a communication link between the learner node and the at least one of the one or more neighbor nodes, and job completion time for the at least one of the one or more neighbor nodes.

10. The learner node as claimed in claim 6, wherein the code that causes the one or more processors to execute code to communicate with the one or more neighbor nodes causes the one or more processors to communicate with the neighbor node based upon the information about the communication link and the job completion time.

11. The learner node as claimed in claim 10, wherein the information about the communication link comprises at least one of amount of time to respond, a selected one of the one or more communication interfaces, a needed precision, power consumption of the neighbor node, and maximum wake time of the neighbor node.

12. The learner node as claimed in claim 6, wherein the code executed by the one or more processors to send the difference to a validator node comprises code to cause the one or more processors to send the differences to one of the one or more validator nodes based upon information about a communication link between the learning node and the one validator node.

13. The learner node as claimed in claim 6, wherein the code that causes the one or more processors to adjust the trained model comprises code that causes the one or more processors to adjust weights in the trained model based upon the inputs.

14. The learner node as claimed in claim 6, wherein the one or more processors are further configured to execute code to receive a maximum time for completion of the trained model.

15. The learner node as claimed in claim 6, wherein upon completion of the trained model, the learning node becomes at least one of a neighbor node or a validator node.

16. The learner node as claimed in claim 6, wherein the one or more processors are further configured to execute code to store in the memory one or more of trained model histories and versions, completion times for the one or more neighbor nodes and the one or more validator nodes.

17. The learner node as claimed in claim 6, wherein the one or more processors are further configured to participate in a communications network as a sensor node operating the trained model upon completion of the trained model.
